(19) United States
(12) Patent Application Publication
(10) Pub. No.: US 2008/0228719 A1
(43) Pub. Date: Sep. 18, 2008

(54) People and business search result optimization

(75) Inventors: Raj Vasant Abhyanker, Cupertino, CA (US); Chandrasekhar Thota, Palo Alto, CA (US)

Correspondence Address: PILLSBURY WINTHROP SHAW PITTMAN LLP, P.O. BOX 10500, MCLEAN, VA, 22102, US

(73) Assignee: Fatdoor, Inc.

(21) Appl. No.: 11/717,808

(22) Filed: Mar. 13, 2007

(51) Int. Cl. G06F 17/30

(52) U.S. Cl. 707/3

(57) ABSTRACT

A method, apparatus, and system of people and business search result optimization are disclosed. In one embodiment, a method includes providing a query prompt to a user to enter a search data, referencing a request of the user of a particular listing with a database and automatically creating a profile having seeded data determined through the request when the request does not have a matching record in the database. The method may further include geo-spatially mapping a location associated with the request when the request includes a location information that is in the database, simultaneously rendering a map with the profile having seeded data based on the geo-spatial mapping of the location associated with the request, creating a marker, visually representing the profile in the map and generating the marker with other markers indicating profiles of an adjacent business and residential listings to the location associated with the profile.

This patent application is being filed simultaneously with a U.S. patent application, titled “PEOPLE AND BUSINESS SEARCH RESULT OPTIMIZATION”.

### FIELD OF TECHNOLOGY

This disclosure relates generally to the technical fields of communications and, in one example embodiment, to a method, apparatus, and system of people and business search result optimization.

### BACKGROUND

A user may enter information to search in a query prompt (e.g., a request for information from a database) of a website (e.g., Fatdoor®, Microsoft Virtual Earth®, Google Earth®, Yahoo Maps®, etc.). The user may request information for which there are no matching records in the database. For example, the user may enter a request for ‘Francis Detromi’ in ‘Columbus, Indiana’, but such a record may not be found in the database. As a result, the user may receive an error message when the request is entered. The user may not visit the website again because the user may be disappointed that the request did not match the record. When an initial experience with the website is not delightful, the user's perception of the website may be lowered. Future searches on the website may be viewed in context of the initial experience, which did not yield positive results.

Sometimes, the request by the user may be for a person and/or a business about whom the user who has some knowledge prior to entering information in the query prompt. For example, the user may know something about ‘Francis Detromi’ in ‘Columbus, Ind.’ prior to entering this information in the query prompt. However, because the user sees the error message when the record is not found, the user may not be able to share his and/or her knowledge with others.

### SUMMARY

A method, apparatus, and system of people and business search result optimization are disclosed. In one aspect, a method includes providing a query prompt to a user to enter a search data, referencing a request of the user of a particular listing with a database and automatically creating a profile having seeded data determined through the request when the request does not have a matching record in the database.

In addition, the method may include geo-spatially mapping a location associated with the request when the request includes the location information that is in the database, simultaneously rendering a map with the profile having seeded data based on the geo-spatial mapping of the location associated with the request, creating a marker to visually represent the profile in the map and generating the marker along with other markers indicating profiles of an adjacent business and/or residential listings to the location associated with the profile.

The method may also include reducing a time delay associated with displaying the profile having seeded data by generating the profile having seeded data while rendition of the map and/or generation of the marker are in progress. The method may further include confirming an accuracy of the request with the user prior to automatically creating the profile having seeded data and updating the profile based on additional information provided by the user when the profile is automatically created.

In addition, the method may also include referencing the request with a spell check database and/or a linguistic database when confirming the accuracy of the request with the user, prior to automatically creating the profile having seeded data. Moreover, the method may include prompting the user to confirm the automatic creation of the profile after determining that the request does not have the matching record in the database. Further, the method may also include suggesting an alternate listing based on a category, a type, an interest, a location, and/or a demographic when the request does not have the matching record in the database.

The method may also include transforming the profile into a claimable wiki profile when automatically creating the profile, and updating the additional information when any user modifies information in the claimable wiki profile. The method may further include displaying the claimable wiki profile when the request is subsequently entered by other users in the query prompt and securing the claimable wiki profile when the claimable wiki profile is claimed by a verified user in a geo-spatial social network.

Additionally, the method may include automatically merging duplicate listings in the database based on a neural network algorithm that compares the profile having seeded data with other profiles created in the geo-spatial social network based on an identifier and/or location data, generating a city center location to serve as a repository of automatically generated profiles in which street address information is missing and/or invalid in a particular city, creating a distinctive marker indicating multiple records, each needing further verification by the users of the geo-spatial social network at the city center location, and automatically creating profiles based on transferred address data acquired through a plurality of online address and/or contact databases into the geo-spatial social network and associated with the user when the user provides permission of such transfers.

In addition, the method may include creating a moderators group in which certain users of the geo-spatial network are elected to verify and/or ensure accuracy of listings, both wiki and claimed, in a territory allocated to the moderators group and removing certain ones of the listings, both wiki and claimed, based on the request of the moderators group. The method may include performing a spider search of a network (e.g., the Internet) to automatically append additional data, images and/or videos to the profile having seeded data when substantial matches are found between the spider search and the seeded data in the profile. In addition, the method may also include providing another query prompt to the user to enter a group data, referencing another request of the user of a particular group with a groups database, automatically creating a new group titled through the another request when the another request does not have a matching record in the groups database.

The method may include automatically notifying neighboring users to the location of the user associated with the profile having seeded data to encourage the neighboring users to submit additional information in the profile having seeded data and/or to verify its authenticity through a tiered voting system in which a certain number of delete flags are required to remove the profile having seeded data.

In another aspect, a system includes a geo-spatial search server having an auto-add module to ensure that searches are automatically added as records in a database when results are not found and appropriately geo-tagged on a map view and a plurality of client devices coupled to the geo-spatial search server to submit queries to the geo-spatial search server and/or to offer additional information to search queries in which there are no pre-existing records in the database of the geo-spatial search server.

The system may further include a wiki module in the geo-spatial search server to enable registered users to modify content associated with automatically added records in the database of the geo-spatial search server. The system may also include a notification module to alert certain users that are determined by the geo-spatial search server to be physically located adjacent to a location associated with the automatically added search results to verify a legitimacy of the automatically added records.

In yet another aspect, a method includes automatically creating markers having seeded data in a geo-spatial environment when a search criteria does not match data in a database and simultaneously placing created markers alongside adjacent location markers indicating profiles of claimed users and/or unclaimed wiki profiles in a geo-spatial social network based on a location data provided in the search criteria.

The method may include generating a unique marker to indicate a location at which created markers have been aggregated when location information is incomplete, and segmenting the location as one in which unfound search queries can be updated by future wiki contributors in the geo-spatial social network. The method may also include confirming an accuracy of the search criteria with a user prior to automatically creating markers having seeded data, and associating with any of the markers a profile based on additional information provided by the user contemporaneously with the search criteria.

The methods, systems, and apparatuses disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1 is a system view of a geo-spatial search server communicating with client devices through a network in a geo-spatial environment, according to one embodiment.

FIG. 2 is an exploded view of the geo-spatial search server of FIG. 1, according to one embodiment.

FIG. 3 is an exploded view of the merge module of FIG. 1, according to one embodiment.

FIG. 4 is a block diagram of auto added profiles in the geo-spatial environment, according to one embodiment.

FIG. 5 is a user interface view of the auto-add module of FIG. 1, according to one embodiment.

FIG. 6 is a table view showing user profile data referenced by the geo-spatial search server of FIG. 1, according to one embodiment.

FIG. 7 is a user interface view of the spider search module of FIG. 2, according to one embodiment.

FIG. 8 is a diagrammatic system view of a data processing system in which any of the embodiments disclosed herein may be performed, according to one embodiment.

FIG. 9A is a process flow of automatically creating a profile having a seeded data based on the search query, according to one embodiment.

FIG. 9B is a continuation of the process flow of FIG. 9A showing additional processes, according to one embodiment.

FIG. 9C is a continuation of the process flow of FIG. 9B showing additional processes, according to one embodiment.

FIG. 9D is a continuation of the process flow of FIG. 9C showing additional processes, according to one embodiment.

FIG. 9E is a continuation of the process flow of FIG. 9D showing additional processes, according to one embodiment.

FIG. 10 is a process flow of automatically creating markers having seeded data in the geo-spatial environment, according to one embodiment.

Other features of the present embodiments will be apparent from the accompanying drawings and from the detailed description that follows.

### DETAILED DESCRIPTION

A method, apparatus, and system of people and business search result optimization are disclosed. In the following description, for the purposes of explanation, numerous specific details are set forth in order to provide a thorough understanding of the various embodiments. It will be evident, however, to one skilled in the art that the various embodiments may be practiced without these specific details.

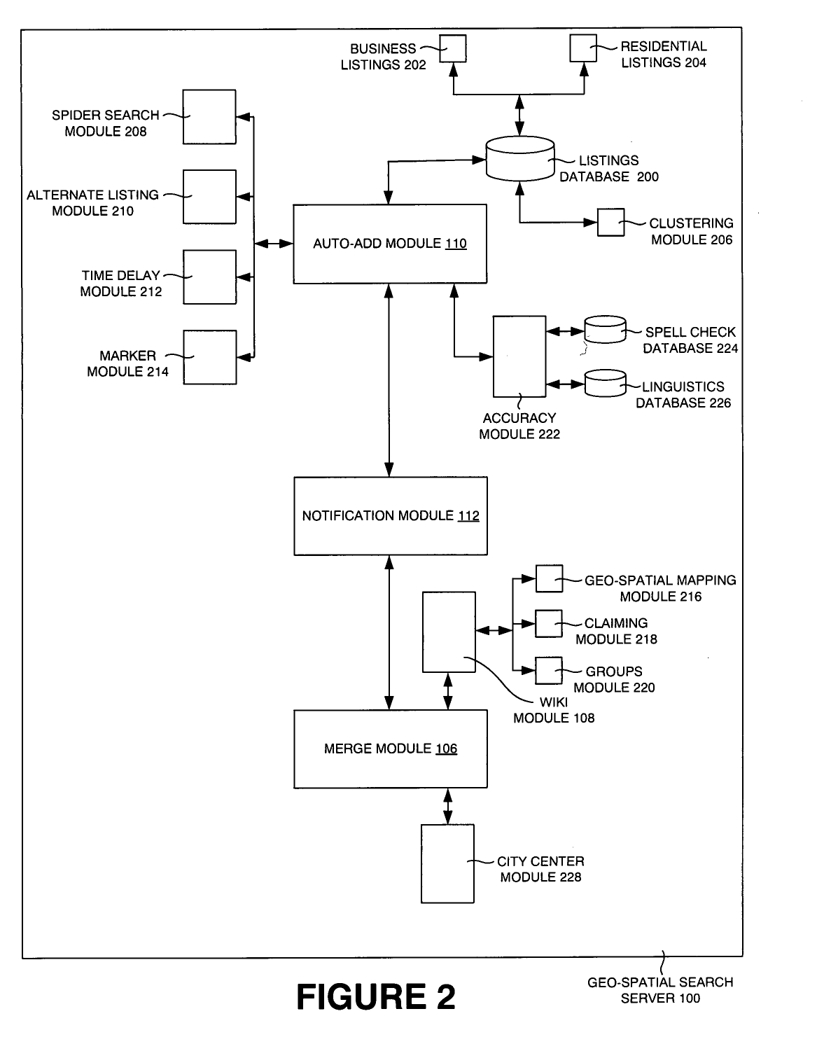

In one embodiment, a method includes providing a query prompt to a user to enter a search data, referencing a request of the user of a particular listing with a database (e.g., the listings database 200 of FIG. 2) and automatically creating a profile having seeded data determined through the request when the request does not have a matching record in the database.

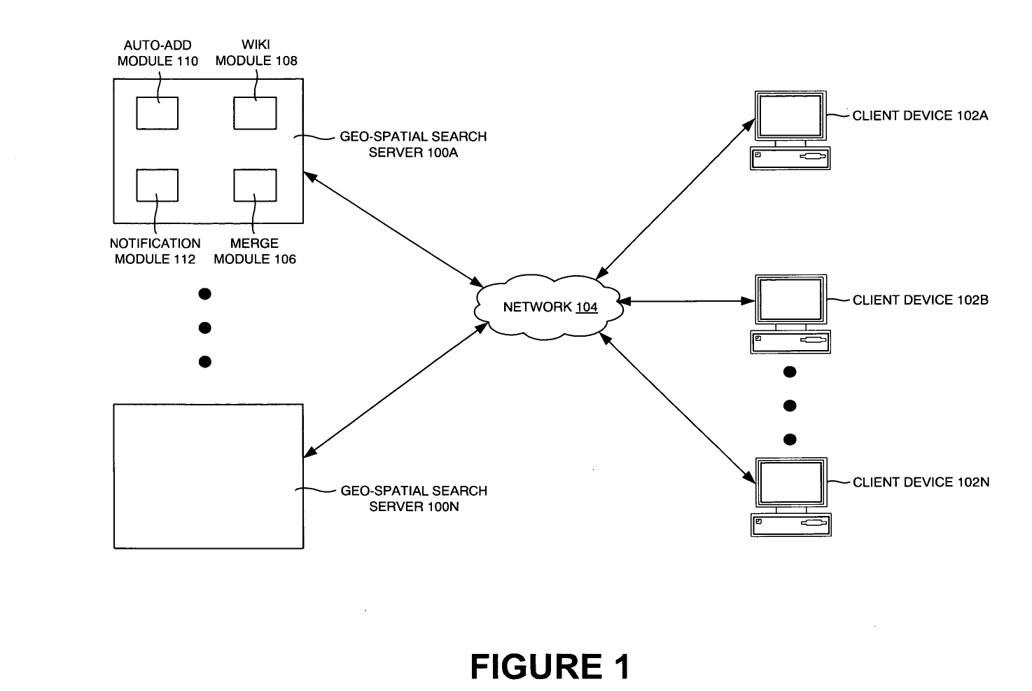

In another embodiment, a system includes a geo-spatial search server (e.g., the geo-spatial search server 100A-N of FIG. 1) having an auto-add module (e.g., the auto-add module 110 of FIG. 1) to ensure that searches are automatically added as records in a database when results are not found and appropriately geo-tagged on a map view and any number of client devices (e.g., the client devices 102A-N of FIG. 1) coupled to the geo-spatial search server to submit queries to the geo-spatial search server and/or to offer additional information to search queries in which there are no pre-existing records in the database of the geo-spatial search server.

In yet another embodiment, a method includes automatically creating markers (e.g., the marker module 214 of FIG. 2) having seeded data in a geo-spatial environment when a search criteria does not match data in a database and simultaneously placing created markers alongside adjacent location markers indicating profiles of claimed users and unclaimed wiki profiles in a geo-spatial social network based on a location data provided in the search criteria.

FIG. 1 is a system view of a geo-spatial search server (e.g., the geo-spatial search servers 100A-N) communicating with client devices 102A-N through a network 104 (e.g., the internet) in a geo-spatial environment, according to one embodiment. Particularly, FIG. 1 illustrates the geo-spatial search servers 100A-N, the client devices 102A-N, the network 104, a merge module 106, a wiki module 108, an auto-add module 110 and a notification module 112, according to one embodiment.

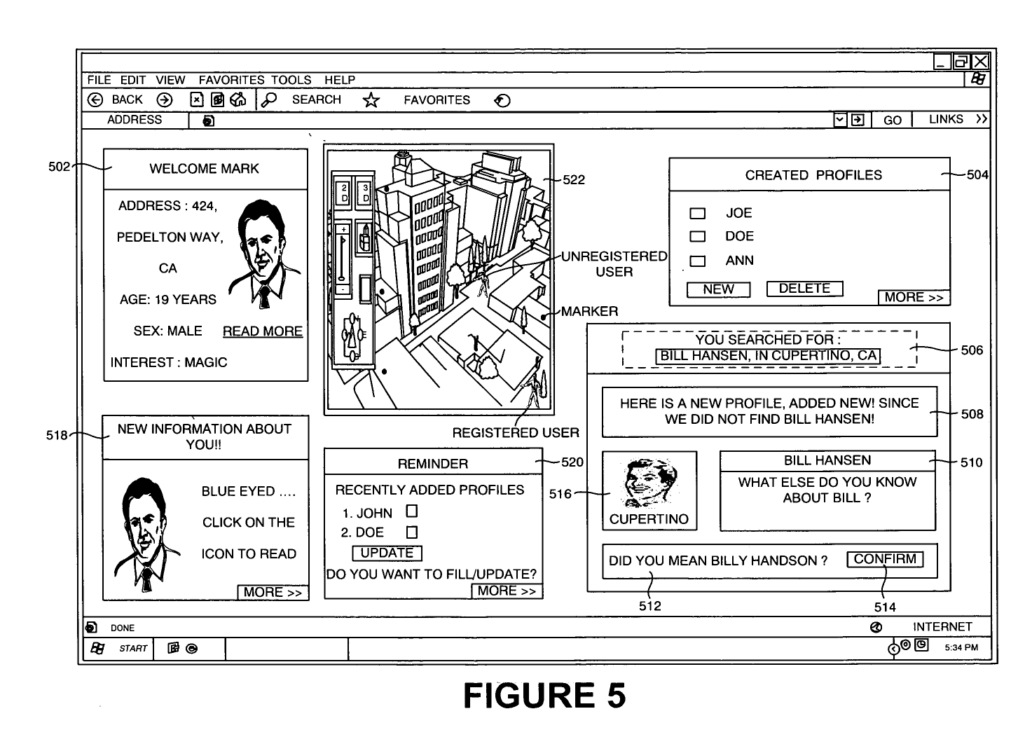

The geo-spatial search servers 100A-N may reference a request with a database (e.g., the listings database 200 of FIG. 2) to process a query submitted by users in the geo-spatial environment (e.g., the geo-spatial environment 522 of FIG. 5). The client device 102A-N may be coupled to the geo-spatial search server 100A-N to submit the query and/or to offer additional information to search queries requested by the user, when the information requested by the user does not match with the records in the database of the geo-spatial environment.

The network 104 may facilitate communication between the geo-spatial search server 100A-N and the client device 102A-N to process the query requested by the user in the geo-spatial environment. The merge module 106 may automatically merge redundant profiles in duplicate listings in the database of the geo-spatial environment (e.g., using a neural network algorithm). The wiki module 108 in the geo-spatial search server may enable registered users to modify content associated with automatically added records in the database of the geo-spatial search server.

The auto-add module 110 may ensure that searches are automatically added as records in the database when the information requested by the user does not match with the records in the database of the geo-spatial environment. The notification module 112 may notify neighbors of the user whose claimable wiki profile is created in the geo-spatial environment to submit additional information in the claimable wiki profile and to verify its authenticity (e.g., through a tiered voting system).

In the example embodiment illustrated in FIG. 1, the geo-spatial search server 100A-N communicates with the client device 102A-N through the network 104. A query prompt may be provided to the user (e.g., to enter a search keyword and/or data). The profile having seeded data determined through the request may be created automatically when the request does not have a matching record in the database (e.g., the listings database 200 of FIG. 2). The profile may be transformed into a claimable wiki profile when the profile is automatically created. In one embodiment, the claimable wiki profile may be secured when the claimable wiki profile is claimed by the verified user (e.g., a registered user) in the geo-spatial social network.

The duplicate listings in the database may be merged (e.g., using the merge module 106 of FIG. 1) automatically based on the neural network algorithm, that compares the profile having seeded data with other profiles created in the geo-spatial social network based on the identifier and/or the location data. Neighboring users (e.g., to the location of the user associated with the profile having seeded data, in the geo-spatial environment) may be notified (e.g., using the notification module 112 of FIG. 1-2) automatically to encourage the neighboring users to submit additional information in the profile having seeded data and/or to verify its authenticity through a tiered voting system (e.g., in which a certain number of delete flags are required to remove the profile having the seeded data).

The geo-spatial search server 100A-N having the auto-add module 110 may be used to ensure that searches are automatically added as records in the database (e.g., the listings database 200 of FIG. 2) when results are not found and/or appropriately geo-tagged on a map view. The client devices 102A-N may be coupled to the geo-spatial search server 100A-N to submit queries to the geo-spatial search server 100A-N and/or to offer additional information to search queries in which there are no pre-existing records in the database of the geo-spatial search server 100A-N.

The wiki module 108 in the geo-spatial search server 100A-N may enable the registered users to modify content associated with automatically added records in the database of the geo-spatial search server 100A-N. The notification module 112 may alert certain users (e.g., that are determined by the geo-spatial search server 100A-N to be physically located adjacent to the location associated with the automatically added search results) to verify a legitimacy of the automatically added records.

FIG. 2 is an exploded view of the geo-spatial search server 100A-N of FIG. 1, according to one embodiment. Particularly, FIG. 2 illustrates the merge module 106, the wiki module 108, the auto-add module 110, the notification module 112, a listings database 200, business listings 202, residential listings 204, a clustering module 206, a spider search module 208, an alternate listing module 210, a time delay module 212, a marker module 214, a geo-spatial mapping module 216, a claiming module 218, a groups module 220, an accuracy module 222, a spell check database 224, a linguistic database 226 and a city center module 228, according to one embodiment.

The merge module 106 may merge duplicate listings (e.g., using a neural network algorithm) in the database to compare a profile with seeded data and other profiles created in the geo-spatial social network. The comparison may be based on the identifier and location data of the user whose profile is created. The wiki module 108 may create claimable wiki profiles that are modified by registered users of the geo-spatial environment. The wiki module 108 may enable the registered users to modify the content of the wiki profiles of users in the geo-spatial social network. The auto-add module 110 may ensure that searches are automatically added as records in the database when the information requested by the user does not match with the records in the database of the geo-spatial environment.

The notification module 112 may alert certain users (e.g., the certain users may be the users in the immediate neighborhood of the user whose profile is being created in the geo-spatial environment through the auto-add module 110) to encourage them to submit the additional information to the claimable wiki profiles. The listings database 200 may contain records (e.g., a category, a type, interests, location, a demographic, etc.) that are matched when the request of the user is referenced with the particular listings in the database. The business listings 202 may contain the profiles associated with a business in the neighborhood of the geo-spatial environment.

The residential listings 204 may contain information associated with residential profiles in the neighborhood. The clustering module 206 may cluster the geo-spatial search server 100A-N with each server having segmented and/or partitioned data that forms the geo-spatial network. The spider search module 208 may perform a spider search to automatically append additional data, images and/or videos to the profile having the seeded data when substantial searches are found between the spider search and the seeded data in the profile. The alternate listing module 210 may reference the alternate listings provided by the user with alternate lists when the request provided by the users does not match with the records in the database of the geo-spatial environment. The time delay module 212 may reduce the time delay associated with displaying the profile having the seeded data when the user enters the request.

The time delay may be reduced by generating the profile while rendition of maps (e.g., a map of the location associated with the request) and generation of markers (e.g., a marker may visually represent the profile) are in progress. The marker module 214 may create markers in the geo-spatial environment to visually represent the profiles created by the registered users. The geo-spatial mapping module 216 may geo-spatially map the location based on the location information requested by the user available in the database (e.g., the listings database 200). The claiming module 218 may secure the claimable wiki profile when it is claimed by the verified registered user in the geo-spatial social network.

The groups module 220 may enable group creation when the group data requested by the user does not have matching records in the groups database of the geo-spatial environment. In addition, the groups module may enable the creation of a moderators group in which certain users are elected to verify and/or to ensure accuracy of the listings (e.g., wiki and claimed) in a territory allocated to the moderators group. The accuracy module 222 may confirm accuracy of the request with the user before the profile having the seeded data is created in the geo-spatial environment.

The spell check database 224 may reference the request of the user with the listings in the database for a spell check and the linguistic database 226 may reference the request for a linguistic check while confirming the accuracy of the request with the user in the geo-spatial environment. The city center module 228 may serve as a repository of automatically generated profiles when the profile information is incomplete (e.g., street address information may be missing and/or invalid in a particular city).

In the example embodiment illustrated in FIG. 2, the listings database 200 communicates with the auto-add module 110 and the clustering module 206. The merge module 106 communicates with the wiki module 108, the notification module 112 and the city center module 228. The wiki module 108 communicates with the merge module 106, the geo-spatial mapping module 216, the claiming module 218 and the groups module 220, according to the example embodiment of FIG. 2.

The auto-add module 110 communicates with the listings database 200, the spider search module 208, the alternate listing module 210, the time delay module 212, the marker module 214 and the accuracy module 222, as illustrated in the example embodiment of FIG. 2. The notification module 112 communicates with the merge module 106 and the auto-add module 110. The accuracy module 222 communicates with the spell check database 224 and the linguistic database 226. The geo-spatial mapping module 216 may communicate with the wiki module 108, according to the example embodiment of FIG. 2.

The request of the user may be referenced with a particular listing of the database (e.g., through the listings database 200 of FIG. 2). Also, the location associated with the request may be geo-spatially mapped when the request includes location information that is in the database. Moreover, the map with the profile having seeded data may be rendered simultaneously based on the geo-spatial mapping of the location associated with the request. In addition, a marker may be created (e.g., using the marker module 214 of FIG. 2) to visually represent the profile in the map. Moreover, the marker along with other markers indicating profiles of the adjacent business and residential listings may be generated in the location associated with the profile.

The time delay associated with displaying the profile having seeded data may be reduced (e.g., using the time delay module 212 of FIG. 2) by generating the profile having the seeded data while rendition of the map and/or generation of the marker are in progress. Also, the accuracy of the request may be confirmed (e.g., through the accuracy module 222 of FIG. 2) with the user prior to automatically creating the profile having the seeded data. Moreover, the request with the spell check database 224 and/or the linguistic database 226 may be referenced when confirming the accuracy of the request with the user prior to automatically creating the profile having seeded data.

An alternate listing (e.g., using the alternate listing module 210 of FIG. 2) based on various criteria (e.g., category, type, interest, location, and/or demographic, etc.) may be suggested when the request does not have a matching record in the database. Furthermore, the profile may be transformed into a claimable wiki profile when the profile is created automatically. Additionally, the claimable wiki profile may be secured when the claimable wiki profile is claimed by the verified user in the geo-spatial social network.

Duplicate listings in the database may be merged (e.g., using the merge module 106 of FIG. 1) automatically based on the neural network algorithm that compares the profile having the seeded data with other profiles created in the geo-spatial social network based on the identifier and/or the location data. Also, a city center location may be generated (e.g., using a city center module 228 of FIG. 2) to serve as a repository of automatically generated profiles in which street address information is missing and/or invalid in the particular city. Furthermore, distinctive markers indicating multiple records (e.g., each needing further verification by the users of the geo-spatial social network) may be created at the city center location. The profiles may be created automatically based on transferred address data acquired through any number of online address and/or contact databases into the geo-spatial social network and/or may be associated with the user when the user provides permission of such transfers.

Additionally, a spider search of the network (e.g., the internet) may be performed (e.g., using the spider search module 208 of FIG. 2) to automatically append additional data, images and/or videos to the profile having seeded data when some substantial matches are found between the spider search and the seeded data in the profile. Furthermore, another request of the user of the particular group may be referenced with the groups' database.

Also, a new group titled through another request may be created automatically when the request does not have a matching record in the groups database. Neighboring users to the location of the user associated with the profile having the seeded data may be notified (e.g., using the notification module 112 of FIG. 1) automatically to encourage the neighboring users to submit additional information in the profile having seeded data and/or to verify its authenticity through a tiered voting system in which a certain number of delete flags are required to remove the profile having seeded data.

The geo-spatial search server 100A-N having the auto-add module 110 may be used to ensure that searches are automatically added as records in the database (e.g., the listings database 200 of FIG. 2) when results are not found and/or appropriately geo-tagged on the map view. In addition, the system may include the wiki module 108 in the geo-spatial search server 100A-N to enable registered users to modify content associated with automatically added records in the database of the geo-spatial search server 100A-N. The notification module 112 may alert certain users that are determined by the geo-spatial search server 100A-N to be physically located adjacent to the location associated with the automatically added search results to verify the legitimacy of the automatically added records.

Markers having seeded data may be created in the geo-spatial environment (e.g., a geo-spatial environment 522 of FIG. 5) when the search criteria does not match data in the database. The created markers may be simultaneously placed alongside adjacent location markers, indicating the profiles of claimed users and/or unclaimed wiki profiles in the geo-spatial social network based on the location data provided in the search criteria. Furthermore, a unique marker may be generated to indicate the location at which the created markers have been aggregated when location information is incomplete. The profile may be automatically associated with the markers based on the additional information provided by the user contemporaneously with the search criteria.

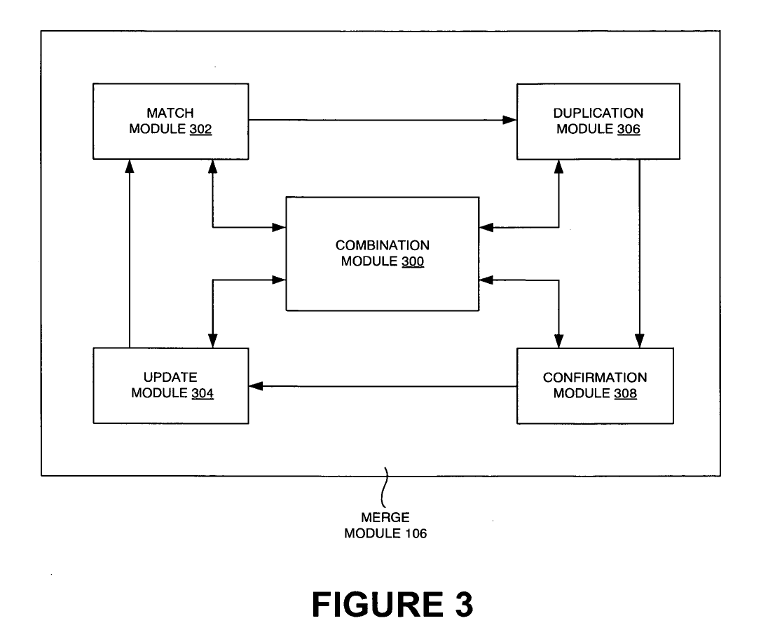

FIG. 3 is an exploded view of the merge module 106 of FIG. 1, according to one embodiment. Particularly, FIG. 3 illustrates a combination module 300, a match module 302, an update module 304, a duplication module 306 and a confirmation module 308, according to one embodiment. The combination module 300 may combine the duplicate listings in the database to compare the profile having the seeded data with the other profiles in the geo-spatial network. The match module 302 may match the profile details having the seeded data with the other profiles created in the geo-spatial environment so that a complete profile is available when the request is subsequently entered by the other users in the geo-spatial environment.

The update module 304 may update and/or append the additional information obtained through matching (e.g., using the match module 302 of FIG. 3) of the profile having seeded data with the profiles created in the geo-spatial social network. The matching may be done based on the identifier and/or the location data of the users of the geo-spatial environment. The duplication module 306 may duplicate the database listings to compare the profiles having the seeded information with the profiles created in the geo-spatial social network, to generate additional information that may be updated (e.g., using the update module 304 of FIG. 3) in the profiles.

The confirmation module 308 may confirm the accuracy of the additional information generated through the matching of the profile having seeded data with the profiles created in the geo-spatial social network (e.g., so that the additional information may be appended). In the example embodiment illustrated in FIG. 3, the combination module 300 communicates with the match module 302, the update module 304, the duplication module 306 and the confirmation module 308. The match module 302 communicates with the duplication module 306 which communicates with the confirmation module 308. The confirmation module 308 communicates with the update module 304 which communicates with the match module 302, according to the example embodiment of FIG. 3.

The accuracy of a request may be confirmed with a user prior to automatically creating the profile having the seeded data. In addition, the profile (e.g., based on additional information provided by the user) may be updated (e.g., using the update module 304) when the profile is automatically created. Also, the user may be prompted to confirm the automatic creation of the profile after determining that the request does not have the matching record in the database (e.g., the listings database 200 of FIG. 2).

The additional information may be updated when any user modifies information in the claimable wiki profile. Additionally, duplicate listings in the database may be merged automatically based on the neural network algorithm that compares the profile having seeded data with other profiles created in the geo-spatial social network based on the identifier and location data. Moreover, certain ones of the listings, (e.g., both wiki and claimed), may be removed based on a request of the moderators group.

Furthermore, the location may be segmented as one in which unfound search queries can be updated by future wiki contributors in the geo-spatial social network. Also, the accuracy of the search criteria may be confirmed with the user prior to automatically creating markers having seeded data.

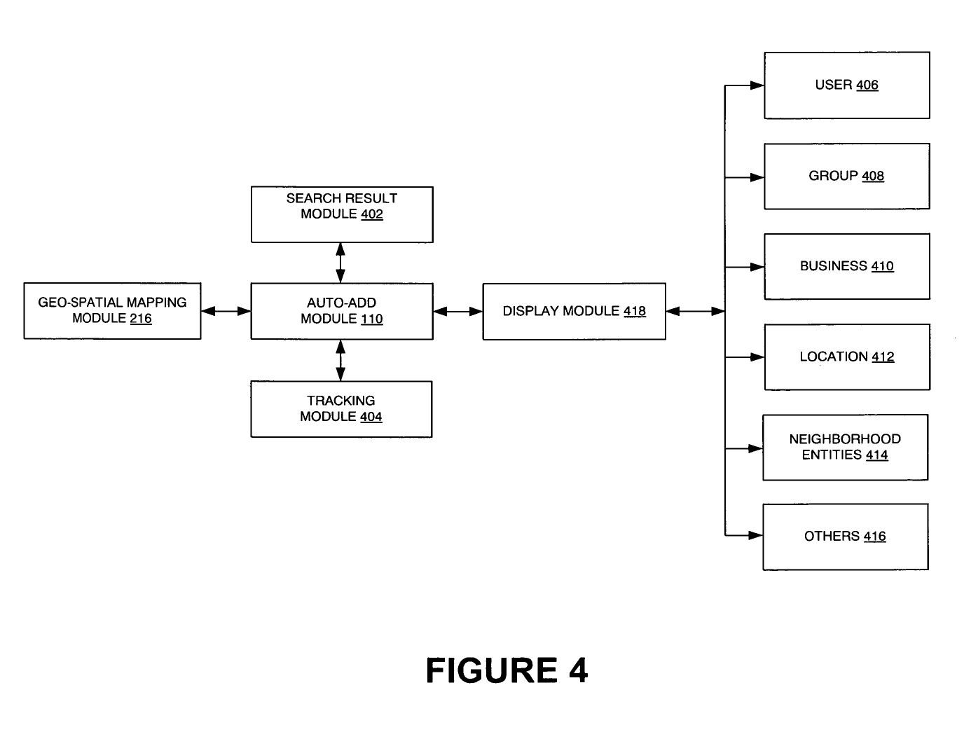

FIG. 4 is a block diagram of the auto added profiles, according to one embodiment. Particularly, FIG. 4 illustrates the auto-add module 110, the geo-spatial mapping module 216, a search result module 402, a tracking module 404, a user 406, a group 408, a business 410, a location 412, neighborhood entities 414, others 416, display module 418, according to one embodiment.

The search result module 402 may display the search results of the geo-spatial search server (e.g., the geo-spatial search server 100A-N), that may have the auto-add module 110. The auto-add module 110 may automatically create the profile associated with the seeded data when the user request does not match the records in the database. The tracking module 404 may enable the user to track the recently added profiles in the database and/or may allow the user to modify and/or update the profiles in the future.

The tracking module 404 may enable the user to track the recently added profiles from the database under various categories such as the user 406, group 408, business 410, location 412, neighborhood entities 414 and others 416 depending on the information stored in the database. The display module 418 may display the recently added profiles on the homepage/login page to remind the user to update the unfilled data in the created profiles. The geo-spatial mapping module 216 may automatically map the location of the recently added profiles associated with the user request when the request includes the location information that may be in the database.

In one example embodiment illustrated in FIG. 4, the auto-add module 110 communicates with the search result module 402, the tracking module 404, the display module 418, and the geo-spatial mapping module 216. The tracking module 404 communicates with the user 406, group 408, business 410, location 412, neighborhood entities 414, and others 416. Furthermore, the location associated with the request may be geo-spatially mapped when the request includes location information that is in the database. Moreover, the map with the profile having seeded data may be rendered simultaneously based on the geo-spatial mapping of the location associated with the request. Also, the claimable wiki profile may be displayed when the request is subsequently entered by other users in the query prompt.

Additionally, the moderators group in which certain users of the geo-spatial network are elected may be created to verify and/or ensure accuracy of listings, both wiki and claimed, in a territory allocated to the moderators group. Furthermore, another query prompt may be provided to the user to enter a group data.

FIG. 5 is a user interface view of the auto-add module 110 of FIG. 1, according to one embodiment. Particularly, FIG. 5 illustrates a user profile 502, a created profiles block 504, a search option 506, an option 508, an option 510, an option 512, a confirm option 514, a location option 516, a comment box 518, a reminder option 520 and a geo-spatial environment 522, according to one embodiment.

The user profile 502 may display location information (e.g., city, country, zip code, etc.) and/or personal information (e.g., name, age, hobbies, etc.) associated with the profile of the registered user. The created profiles block 504 may enable the user to view the list of created profiles associated with the user in the neighborhood and/or may also enable the user to update content associated with the particular wiki profile. In addition, the created profiles option 504 may include a delete option to delete any one of the created profiles based on the user request.

The search option 506 may show the search query (e.g., name, location, profession, etc.) requested by the user. The option 508 may automatically create a new profile with seeded data when the search result does not have a matching record in the database. The option 510 may enable the user to submit additional information associated with the newly created profile (e.g., other than the seeded data). The option 512 may query the user to confirm the accuracy of the request prior to automatically creating the profile having the seeded data.

The confirm option 514 may prompt the user to confirm the automatic creation of the profile after determining that the request does not have a matching record in the database. The location option 516 may display the image and/or the location associated with the search query requested by the user. The comment box 518 may enable the user to view the comments posted by other users in the geo-spatial environment 522. The reminder option 520 may remind the user about the recently added profiles and/or may also enable the user to update and/or view the content data associated with the profile through the update link. The geo-spatial environment 522 may graphically represent any number of markers associated with the profiles marked above the 3-dimensional view in the neighborhood.

In one example embodiment illustrated in FIG. 5 the user interface view 500 may display the verified registered user profile and the created profiles (e.g., the created profiles of the other users) associated with the users in the neighborhood. The reminder option 520 may remind the user about the incomplete data in the profiles and/or may allow the user to update the incomplete profiles.

The user interface view 500 as illustrated in the example embodiment of FIG. 5 may also enable the user to search for the profile data requested by the user and/or may automatically create the profile having seeded data determined through the request when the request does not have a matching record in the database. The other users may be allowed to post the comments on the registered user displayed through the comment box 518. The geo-spatial environment 522 may graphically visualize the markers placed adjacent to profiles of claimed users (e.g., registered users) and/or unclaimed wiki profiles in the geo-spatial social network based on the location data provided in the search criteria.

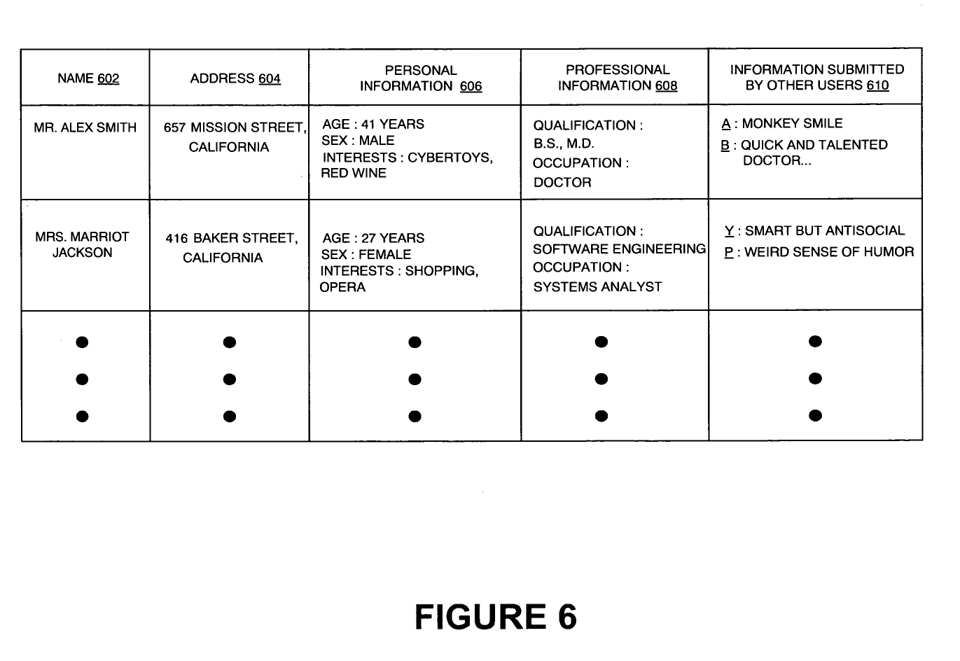

FIG. 6 is a table view showing user profile data referenced by the geo-spatial search server 100A-N of FIG. 1, according to one embodiment. Particularly, FIG. 6 illustrates a name field 602, an address field 604, a personal information field 606, a professional information field 608 and information submitted by other user field 610, according to one embodiment.

The name field 602 may display the names of users in the geo-spatial environment. The address field 604 may display the address(es) of the user(s) (e.g., provided by the users). The personal information field 606 may display personal information (e.g., the personal information may include age, sex, interests, etc.) about the users. The professional information field 608 may display professional data (e.g., the professional data may include qualification, occupation, etc.) of the users in the geo-spatial environment. The information displayed in the other user field 610 may reference data contained in the claimable wiki profile(s) created by the registered user(s) in the geo-spatial environment.

In the example embodiment illustrated in FIG. 6, the name field 602 displays “Mr. Alex Smith” in the first row and “Mrs. Marriot Jackson” in the second row of the name field column 602. The address field 604 displays “657 Mission Street, California” in the first row and “416 Baker Street, California” in the second row of the address field column 604. The personal information field 606 displays “Age: 41 years, Sex: Male, Interest: Cyber toys, red wine” in the first row and “Age: 27 years, Sex: Female, Interest: Shopping, opera” in the second row of the personal information field column 606.

The Professional information field 608 displays “Qualification: B.S., M.D., Occupation: Doctor” in the first row and “Qualification: Software Engineer, Occupation: Systems Analyst” in the second row of the professional information field column 608. The information submitted by other users field 610 displays “A: Monkey smile, B: Quick and talented doctor” in the first row and “Y: Smart but antisocial, P: Weird sense of humor” in the second row of the information submitted by other users field column 610.

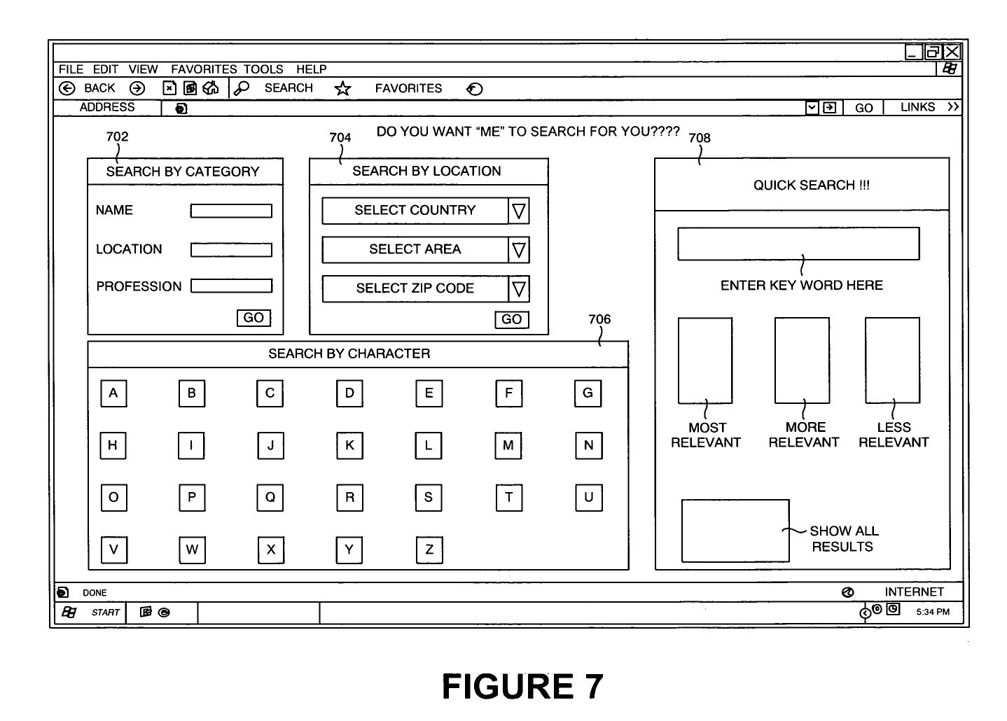

FIG. 7 is a user interface view of the spider search module 208 of FIG. 2, according to one embodiment. Particularly, FIG. 7 illustrates a search by category option 702, a search by location option 704, a search by character option 706 and a quick search option 708, according to one embodiment.

The search by category option 702 may provide the query prompt to the user to enter search data based on a category (e.g., name, location, profession, etc.). The search by location option 704 may search for the data associated with the address data (e.g., country, area, zip code, etc.) by referencing the request of the user with the listings in the database. The search by character option 706 may display all the results associated with a particular alphabet when the user selects the particular alphabet. The quick search option 708 may prompt the user to enter the key words associated with the targeted profile data which may display relevant information associated with the user requested keyword.

In one example embodiment illustrated in FIG. 7 the user interface view 700 may search the profiles associated with content data (e.g., name, location, profession etc.) by referencing the request of the user of the particular listing with the database. The user may be enabled to search the data (e.g., based on the category, the location, the character and/or the keyword, etc.). The search result may display all the relevant information associated with the user requested search data.

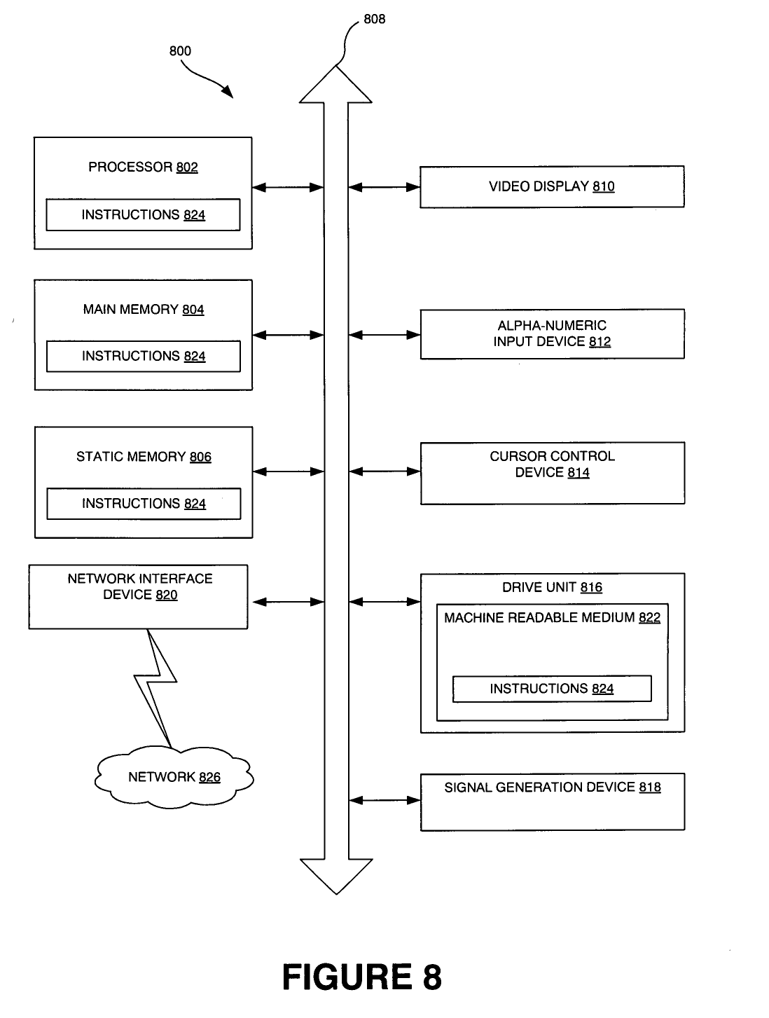

FIG. 8 is a diagrammatic system view 800 of a data processing system in which any of the embodiments disclosed herein may be performed, according to one embodiment. Particularly, the diagrammatic system view 800 of FIG. 8 illustrates a processor 802, a main memory 804, a static memory 806, a bus 808, a video display 810, an alpha-numeric input device 812, a cursor control device 814, a drive unit 816, a signal generation device 818, a network interface device 820, a machine readable medium 822, instructions 824, and a network 826, according to one embodiment.

The diagrammatic system view 800 may indicate a personal computer and/or a data processing system in which one or more operations disclosed herein are performed. The processor 802 may be a microprocessor, a state machine, an application specific integrated circuit, a field programmable gate array, etc. (e.g., Intel® Pentium® processor). The main memory 804 may be a dynamic random access memory and/or a primary memory of a computer system.

The static memory 806 may be a hard drive, a flash drive, and/or other memory information associated with the data processing system. The bus 808 may be an interconnection between various circuits and/or structures of the data processing system. The video display 810 may provide graphical representation of information on the data processing system. The alpha-numeric input device 812 may be a keypad, keyboard and/or any other input device of text (e.g., a special device to aid the physically handicapped). The cursor control device 814 may be a pointing device such as a mouse.

The drive unit 816 may be a hard drive, a storage system, and/or other longer term storage subsystem. The signal generation device 818 may be a bios and/or a functional operating system of the data processing system. The network interface device 820 may be a device that may perform interface functions such as code conversion, protocol conversion and/or buffering required for communication to and from the network 826. The machine readable medium 822 may provide instructions on which any of the methods disclosed herein may be performed. The instructions 824 may provide source code and/or data code to the processor 802 to enable any one/or more operations disclosed herein.

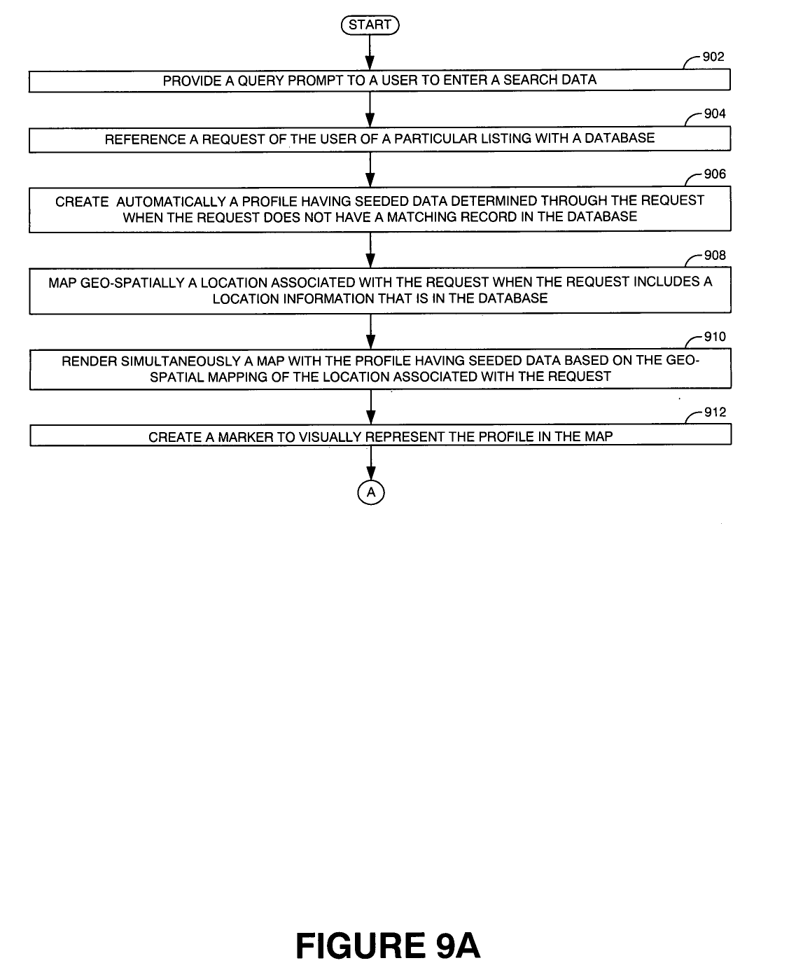

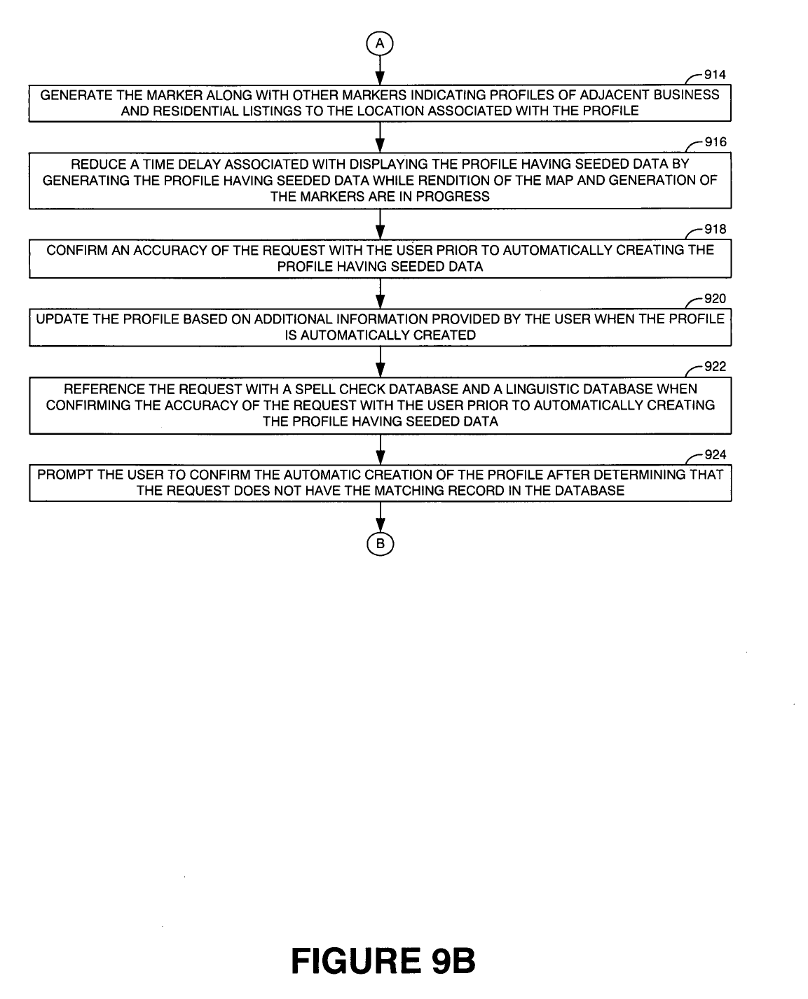

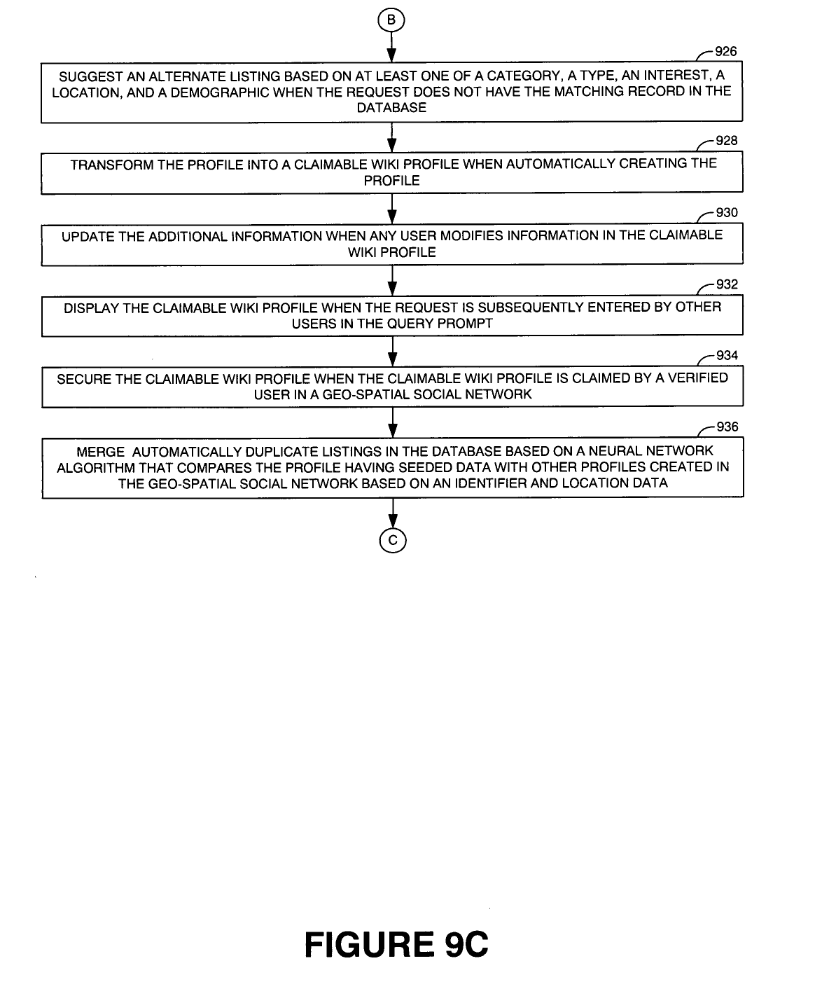

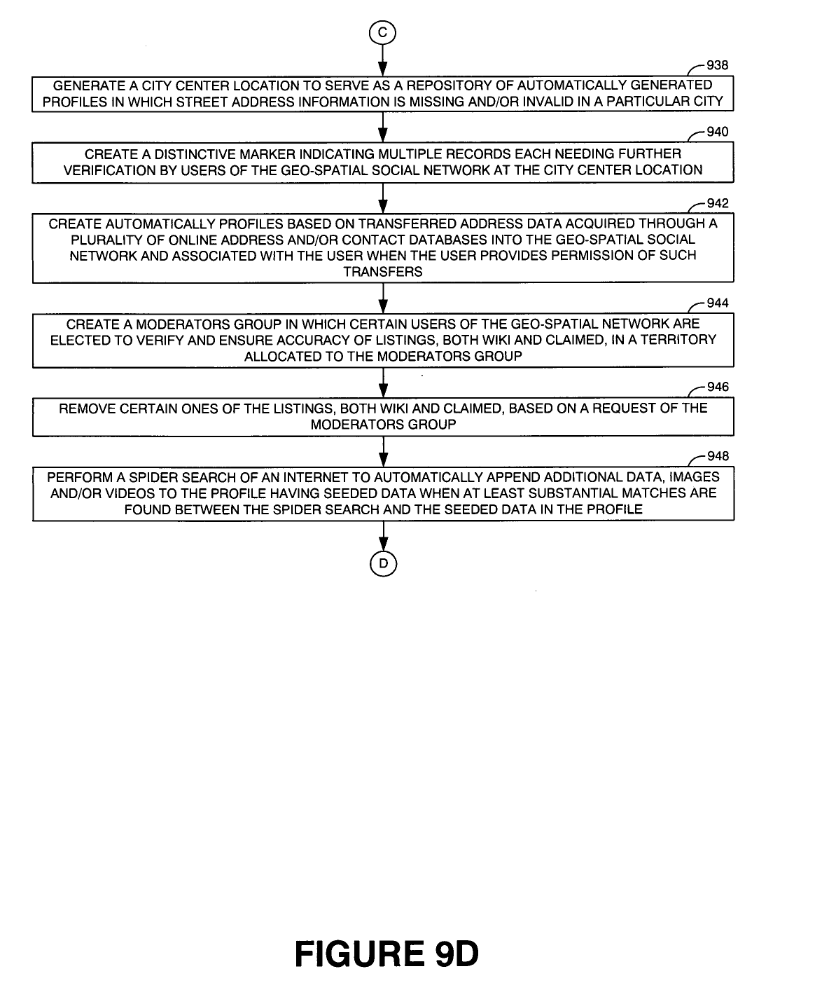

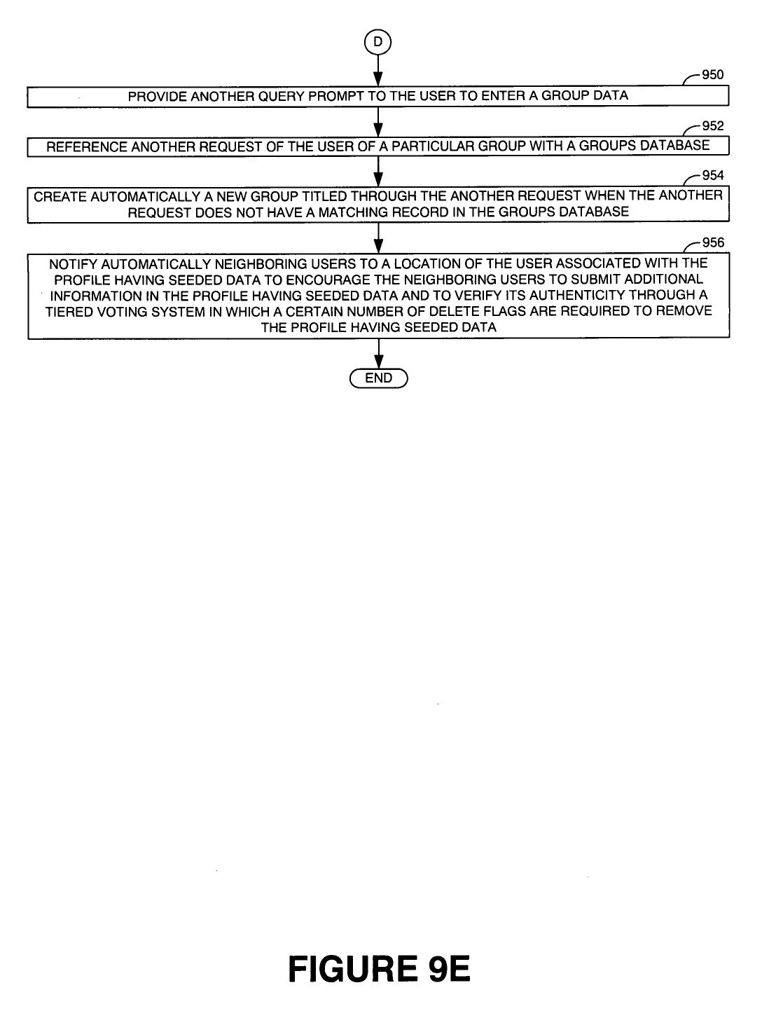

FIG. 9A is a process flow of automatically creating a profile having a seeded data based on the search query, according to one embodiment. In operation 902, a query prompt may be provided to a user to enter a search data. In operation 904, a request of the user of a particular listing of a database may be referenced (e.g., the listings database 200 of FIG. 2). In operation 906, a profile having seeded data determined through the request when the request does not have a matching record in the database may be created automatically.

In operation 908, a location associated with the request may be geo-spatially mapped (e.g., using the geo-spatial mapping module 216 of FIG. 2) when the request includes location information that is in the database. In operation 910, a map may be rendered simultaneously with the profile having seeded data based on the geo-spatial mapping of the location associated with the request. In operation 912, a marker may be created to visually represent the profile in the map.

FIG. 9B is a continuation of the process flow of FIG. 9A showing additional processes, according to one embodiment. In operation 914, the marker may be generated along with other markers indicating profiles of an adjacent business and residential listings to the location associated with the profile. In operation 916, a time delay associated with displaying the profile having seeded data may be reduced by generating the profile having seeded data while the process of rendition of the map and generation of the marker are in progress.

In operation 918, an accuracy of the request may be confirmed with the user (e.g., using the accuracy module 222 of FIG. 2) prior to automatically creating the profile having seeded data. In operation 920, the profile may be updated (e.g., using the update module 304 of FIG. 3) based on additional information provided by the user when the profile is automatically created. In operation 922, the request may be referenced with a spell check database (e.g., the spell check database 224 of FIG. 2) and/or a linguistic database (e.g., the linguistic database 226 of FIG. 2) when confirming the accuracy of the request with the user prior to automatically creating the profile having seeded data. In operation 924, the user may be prompted to confirm the automatic creation of the profile after determining that the request does not have a matching record in the database.

FIG. 9C is a continuation of the process flow of FIG. 9B, showing additional processes, according to one embodiment. In operation 926, an alternate listing (e.g., using the alternate listing module 210 of FIG. 2) may be suggested based on a category, a type, an interest, a location, and/or a demographic when the request does not have the matching record in the database. In operation 928, the profile may be transformed into a claimable wiki profile when automatically creating the profile. In operation 930, the additional information may be updated (e.g., using the update module 304 of FIG. 3) when any user modifies information in the claimable wiki profile.

In operation 932, the claimable wiki profile may be displayed when the request is subsequently entered by other users in the query prompt. In operation 934, the claimable wiki profile may be secured when the claimable wiki profile is claimed by a verified user in a geo-spatial social network. In operation 936, duplicate listings in the database may be merged (e.g., using the merge module 106 of FIG. 1) automatically based on a neural network algorithm that compares the profile having seeded data with other profiles created in the geo-spatial social network based on an identifier and location data.

FIG. 9D is a continuation of the process flow of FIG. 9C showing additional processes, according to one embodiment. In operation 938, a city center location (using the city center module 228 of FIG. 2) may be generated to serve as a repository of automatically generated profiles in which street address information is missing and/or invalid in a particular city. In operation 940, a distinctive marker may be created (e.g., using the marker module 214 of FIG. 2) indicating multiple records, each needing further verification by users of the geo-spatial social network at the city center location. In operation 942, profiles may be created automatically based on transferred address data acquired through a plurality of online address and/or contact databases into the geo-spatial social network and associated with the user when the user provides permission of such transfers.

In operation 944, a moderators group may be created in which certain users of the geo-spatial network are elected to verify and/or ensure accuracy of listings, both wiki and claimed, in a territory allocated to the moderators group. In operation 946, certain ones of the listings, both wiki and claimed, may be removed based on a request of the moderators group. In operation 948, a spider search (e.g., using the spider search module 208 of FIG. 2) of an Internet may be performed to automatically append additional data, images and/or videos to the profile having seeded data when at least substantial matches are found between the spider search and the seeded data in the profile.

FIG. 9E is a continuation of the process flow of FIG. 9D, according to one embodiment. In operation 950, another query prompt may be provided to the user to enter a group data. In operation 952, another request of the user of a particular group may be referenced with a groups database. In operation 954, a new group titled through the another request may be created automatically when the another request does not have a matching record in the groups database.

In operation 956, neighboring users to a location of the user associated with the profile having seeded data may be notified (e.g., using the notification module 112 of FIG. 2) automatically to encourage the neighboring users to submit additional information in the profile having seeded data and/or to verify its authenticity through a tiered voting system in which a certain number of delete flags are required to remove the profile having seeded data.

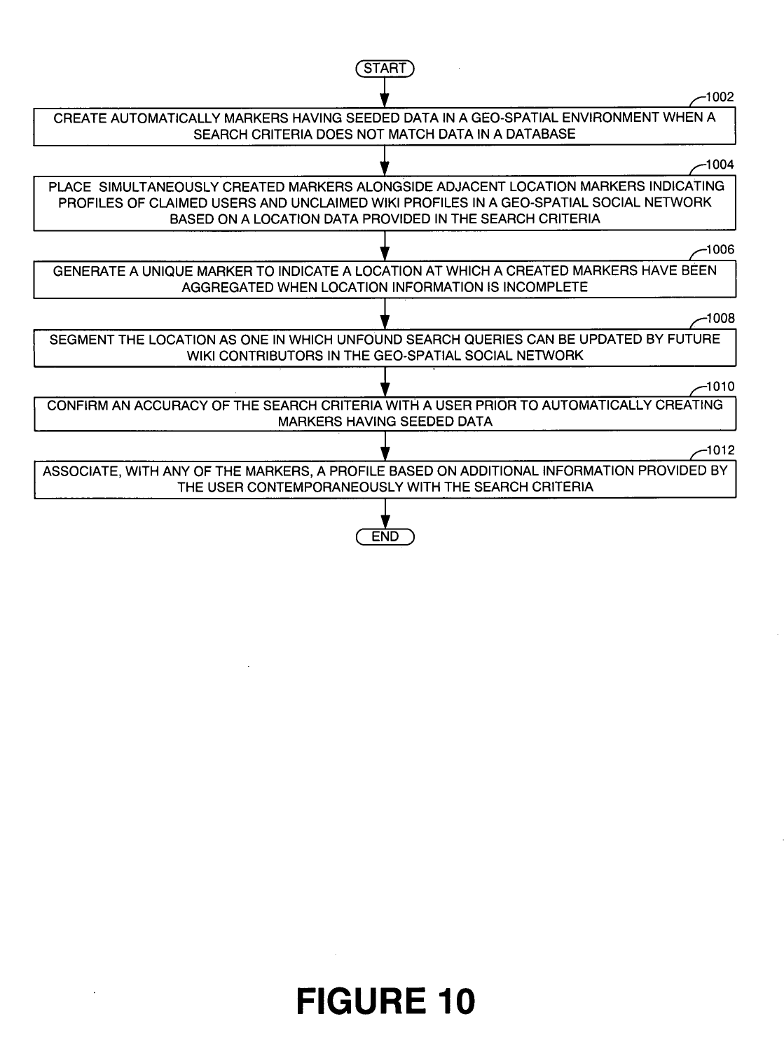

FIG. 10 is a process flow of automatically creating markers in the geo-spatial environment, according to one embodiment. In operation 1002, markers (e.g., using the marker module 214 of FIG. 2) having seeded data may be created automatically in a geo-spatial environment when a search criteria does not match data in a database. In operation 1004, created markers may be placed simultaneously alongside adjacent location markers, indicating profiles of claimed users and unclaimed wiki profiles in a geo-spatial social network based on a location data provided in the search criteria. In operation 1006, a unique marker may be generated (e.g., using the marker module 214 of FIG. 2) to indicate a location at which the created markers have been aggregated when location information is incomplete.

In operation 1008, the location may be segmented as one in which unfound search queries can be updated by future wiki contributors in the geo-spatial social network. In operation 1010, an accuracy of the search criteria may be confirmed (e.g., using the accuracy module 222 of FIG. 2) with a user prior to automatically creating markers having seeded data. In operation 1012, a profile may be associated with any of the markers based on additional information provided by the user contemporaneously with the search criteria.

Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry (e.g., CMOS based logic circuitry), firmware, software and/or any combination of hardware, firmware, and/or software (e.g., embodied in a machine readable medium). For example, the various electrical structure and methods may be embodied using transistors, logic gates, and electrical circuits (e.g., application specific integrated ASIC circuitry and/or in Digital Signal; Processor DSP circuitry).

For example, the merge module 106, the wiki module 108, the auto-add module 110, the notification module 112, the clustering module 206, the spider search module 208, the alternate listing module 210, the time delay module 212, the marker module 214, the geo-spatial mapping module 216, the claiming module 218, the groups module 220, the accuracy module 222, the city center module 228, the combination module 300, the match module 302, the update module 304, the duplication module 306, the confirmation module 308, the tracking module 404, the display module 418 and other modules of FIGS. 1-12 may be enabled using a merge circuit, a wiki circuit, an auto-add circuit, a notification circuit, a clustering circuit, a spider search circuit, an alternate listing circuit, a time delay circuit, a marker circuit, a geo-spatial mapping circuit, a claiming circuit, a groups circuit, an accuracy circuit, a city center circuit, a combination circuit, a match circuit, an update circuit, a duplication circuit, a confirmation circuit, a tracking circuit, a display circuit and other circuits using one or more of the technologies described herein.

In addition, it will be appreciated that the various operations, processes, and methods disclosed herein may be embodied in a machine-readable medium and a machine accessible medium compatible with a data processing system (e.g., a computer system), and may be performed in any order. Accordingly, the specification and drawings are to be regarded in an illustrative rather than a restrictive sense.

What is claimed is:

1. A method comprising:
providing a query prompt to a user to enter a search data;
referencing a request of the user of a particular listing with a database; and
automatically creating a profile having seeded data determined through the request when the request does not have a matching record in the database.

2. The method of claim 1 further comprising:
geo-spatially mapping a location associated with the request when the request includes a location information that is in the database;
simultaneously rendering a map with the profile having seeded data based on the geo-spatial mapping of the location associated with the request;
creating a marker to visually represent the profile in the map; and
generating the marker along with other markers indicating profiles of an adjacent business and residential listings to the location associated with the profile.

3. The method of claim 2 further comprising reducing a time delay associated with displaying the profile having seeded data by generating the profile having seeded data while rendition of the map and generation of the marker are in progress.

4. The method of claim 2 further comprising:
confirming an accuracy of the request with the user prior to automatically creating the profile having seeded data; and
updating the profile based on additional information provided by the user when the profile is automatically created.

5. The method of claim 4 further comprising referencing the request with a spell check database and a linguistic database when confirming the accuracy of the request with the user prior to automatically creating the profile having seeded data.

6. The method of claim 5 further comprising prompting the user to confirm the automatic creation of the profile after determining that the request does not have a matching record in the database.

7. The method of claim 6 further comprising suggesting an alternate listing based on at least one of a category, a type, an interest, a location, and a demographic when the request does not have the matching record in the database.

8. The method of claim 4 further comprising:
transforming the profile into a claimable wiki profile when automatically creating the profile;
updating the additional information when any user modifies information in the claimable wiki profile;
displaying the claimable wiki profile when the request is subsequently entered by other users in the query prompt; and
securing the claimable wiki profile when the claimable wiki profile is claimed by a verified user in a geo-spatial social network.

9. The method of claim 8 further comprising:
automatically merging duplicate listings in the database based on a neural network algorithm that compares the profile having seeded data with other profiles created in the geo-spatial social network based on an identifier and location data;
generating a city center location to serve as a repository of automatically generated profiles in which street address information is al least one of missing and invalid in a particular city;
creating a distinctive marker indicating multiple records each needing further verification by users of the geo-spatial social network at the city center location; and
automatically creating profiles based on transferred address data acquired through a plurality of online address and contact databases into the geo-spatial social network and associated with the user when the user provides permission of such transfers.

10. The method of claim 9 further comprising:
creating a moderators group in which certain users of the geo-spatial network are elected to verify and ensure accuracy of listings, both wiki and claimed, in a territory allocated to the moderators group; and
removing certain ones of the listings, both wiki and claimed, based on the request of the moderators group.

11. The method of claim 1 further comprising performing a spider search of an Internet to automatically append additional data, images and videos to the profile having seeded data when at least substantial matches are found between the spider search and the seeded data in the profile.

12. The method of claim 11 further comprising:
providing another query prompt to the user to enter a group data;
referencing another request of the user of a particular group with a groups database; and
automatically creating a new group titled through the another request when the another request does not have a matching record in the groups database.

13. The method of claim 1 further comprising:
automatically notifying neighboring users to a location of the user associated with the profile having seeded data to encourage the neighboring users to submit additional information in the profile having seeded data and to verify its authenticity through a tiered voting system in which a certain number of delete flags are required to remove the profile having seeded data.

14. The method of claim 1 in a form of a machine-readable medium embodying a set of instructions that, when executed by a machine, causes the machine to perform the method of claim 1.

15. A system comprising:
a geo-spatial search server having an auto-add module to ensure that searches are automatically added as records in a database when results are not found and appropriately geo-tagged on a map view; and
a plurality of client devices coupled to the geo-spatial search server to submit queries to the geo-spatial search server and to offer additional information to search queries in which there are no preexisting records in the database of the geo-spatial search server.

16. The system of claim 15 further comprising a wiki module in the geo-spatial search server to enable registered users to modify content associated with automatically added records in the database of the geo-spatial search server.

17. The system of claim 16 further comprising a notification module to alert certain users that are determined by the geo-spatial search server to be physically located adjacent to a location associated with the automatically added search results to verify a legitimacy of the automatically added records.

18. A method comprising:
automatically creating markers having seeded data in a geo-spatial environment when a search criteria does not match data in a database; and
simultaneously placing created markers alongside adjacent location markers indicating profiles of claimed users and unclaimed wiki profiles in a geo-spatial social network based on a location data provided in the search criteria.

19. The method of claim 18 further comprising:
generating a unique marker to indicate a location at which created markers have been aggregated when location information is incomplete; and
segmenting the location as one in which unfound search queries can be updated by future wiki contributors in the geo-spatial social network.

20. The method of claim 18 further comprising:
confirming an accuracy of the search criteria with a user prior to automatically creating markers having seeded data; and
associating with any of the markers, a profile based on additional information provided by the user contemporaneously with the search criteria.
